(19) United States
(12) Patent Application Publication
(10) Pub. No.: US 2026/0067309 A1
(43) Pub. Date: Mar. 5, 2026

(54) METHODS AND APPARATUSES FOR DETECTING SECURITY ATTACKS IN INTERNET OF SENSES (IOS) APPLICATIONS

(71) Applicant: Telefonaktiebolaget LM Ericsson (publ), Stockholm (SE)

(72) Inventors: Pinar ÇOMAK, Sariyer/Istanbul (TR); Emrah TOMUR, Karabaglar/Izmir (TR); Elif ÜSTÜNDAG SOYKAN, Maslak Istanbul (TR); Ferhat KARAKOÇ, Pendik/Istanbul (TR); Leyli KARAÇAY, Ümraniye/Istanbul (TR); Ramin FULADI, Maltepe/Istanbul (TR); Utku GÜLEN, Kadiköy/Istanbul (TR); Ayse BILGE INCE, Lodon (GB)

(73) Assignee: Telefonaktiebolaget LM Ericsson (publ), Stockholm (SE)

(21) Appl. No.: 19/105,345

(22) PCT Filed: Sep. 27, 2022
(86) PCT No.: PCT/TR2022/051049

§ 371 Date: Feb. 21, 2025

(51) Int. Cl. H04L 9/40; H04W 4/38

(52) U.S. Cl. CPC H04L 63/1425; H04W 4/38

(57) ABSTRACT

A technique for detecting security attacks in Internet of Senses (IoS) applications is disclosed. A method implementation of the technique is performed by a network node (300) and comprises obtaining (S201B), from a sender node (200), sensory data (101) and at least one of network data (102) or context data (103). The method further comprises determining (S301) anomaly by applying at least one of a payload-based analysis or a packet-based analysis. The payload-based analysis is applied to at least one of the sensory data (101) or to the context data (103). The packet-based analysis is applied to the network data (102). The payload-based analysis analyzes a payload of data packets, while the packet-based analysis analyzes a pattern of data packet traffic. The method further comprises transmitting (S302), to a receiver node (400), a result of the determining step (S301).

### TECHNICAL FIELD

The present invention generally relates to detecting security attacks in wireless communication systems. More particularly, a technique for detecting bullying attacks, which are targeted aggressive behavior aiming at harming a person emotionally, mentally, or physically, is presented. The technique may be embodied in methods, computer program products, apparatuses and systems.

### BACKGROUND

For individuals, that are spatially separated from others, physical communication between them is significantly reduced. So, beyond a communication by hearing and seeing via audio/video apps, a need for communication using senses, such as touch, is increased.

An enabler for this need is Internet of Senses (IoS) technology where senses are expected to be included in digital communication using devices, e.g. wearables, and allowing people to digitally feel smelling, tasting, touching on textures and feeling temperature, etc.

NeoTouch is one of the early prototypes of IoS technologies facilitating digital touch in remote communication based on a Brain-Computer Interface (BCI). The NeoTouch allows tactile interaction through your phone and a transducer, named as the Senser. This unit is attached to the skin behind the ear and communicates wirelessly with a network of nano-electronics in the brain to simulate the sensation of being in touch with another person.

A potential danger with IoS technologies where users with malicious intent can use it for threatening or harming or bullying other users. The term “bullying” mainly refers to targeted aggressive behavior that aims at harming a person emotionally, mentally, or physically. When bullying takes place over digital devices, such as cell phones, computers, and tablets, it is referred as “cyberbullying”. The haptic technology as one of the IoS technologies may become a commonly-used element in human-computer interaction in the future where one possible cyberbullying activity would be that the bullying party touches someone in an abusive way and/or without his/her consent.

Social media, online chat rooms, messaging apps on mobile or tablet devices are some common places where the cyberbullying takes place through messages, photos and videos. To predict a cyberbullying in a text, various features are extracted which can be categorized into two groups of content-based and profile-based features. Content-based features are obtained directly from the text, such as Bag of Words (Bow), Skip Gram (SG), Profanity Features (PF), Sentiment Features (SF) and Pronounce (PR). On the other hand, profile-based features are obtained by analyzing the user profile such as demographic features (age, gender etc.), friends of followers count feature, location of post and time stamp. Once features are extracted, they are employed by Machine Learning (ML) or Natural Language Processing (NLP) techniques to predict the cyberbullying incidents within the text. Some existing solutions in the literature make use of deep learning models, such as Convolutional Neural Network (CNN), Recurrent Neural Network (RNN) and semantic image features, for the detection of bullying content by analyzing image based and user features.

However, existing solutions are limited to text-based or image-based analytics but not able to detect or predict the cyberbullying that occur in the form of abusive senses through mobile or web applications, e.g. IoS application.

Accordingly, there is a need for a technique that enables reliable and effective detection of a security attack in IoS applications, facilitating the use of senses.

### SUMMARY

According to a first aspect, a method, performed by a network node for detecting security attacks in IoS applications, is provided. The method comprises obtaining, from a sender node, sensory data and at least one of network data or context data. The method further comprises determining anomaly by applying at least one of a payload-based analysis or a packet-based analysis. The payload-based analysis is applied to at least one of the sensory data or to the context data. The packet-based analysis is applied to the network data. The payload-based analysis analyzes a payload of data packets, while the packet-based analysis analyzes a pattern of data packet traffic. The method further comprises transmitting, to a receiver node, a result of the determining step.

According to an embodiment for the obtaining step, the method further comprises obtaining additional data from the receiver node to be used in the determining step.

According to a second aspect, a method, performed by a sender node for detecting security attacks in IoS applications, is provided. The method comprises obtaining sensory data and at least one of network data and context data. The method further comprises transmitting the sensory data and at least one of the network data and the context data to a network node which determines anomaly by applying at least one of a payload-based analysis or a packet-based analysis. The payload-based analysis is applied to at least one of the sensory data or to the context data. The packet-based analysis is applied to the network data.

According to a third aspect, a method, performed by a receiver node for detecting security attacks in IoS applications, is provided. The method comprises obtaining, from a network node, a result of determining anomaly, wherein the network node applies at least one of a payload-based analysis or a packet-based analysis, wherein the payload-based analysis is applied to at least one of sensory data or to context data, and wherein the packet-based analysis is applied to network data. The sensory data, the context data and the network data are obtained by a sender node. The method further comprises initiating one of at least two different actions depending on the result of the determining anomaly.

According to a fourth aspect, a computer program product for detecting security attacks in IoS applications is provided. The computer program product comprises program code portions that, when executed on at least one processing circuitry, configure the processing circuitry to perform the method of any one of the example implementations in accordance with the first, the second or the third aspect. The computer program product may hereby, in some examples, be stored on a computer-readable storage medium or encoded in a data signal.

According to a fifth aspect, a network node for detecting security attacks in IoS applications is provided. The network node is configured to perform the method of the first aspect. The corresponding embodiments for the method disclosed above are also applicable for the network node.

According to a sixth aspect, a sender node for detecting security attacks in IoS applications is provided. The sender node is configured to perform the method of the second aspect. The corresponding embodiments for the method disclosed above are also applicable for the sender node.

According to a seventh aspect, a receiver node for detecting security attacks in IoS applications is provided. The receiver node is configured to perform the method of the third aspect. The corresponding embodiments for the method disclosed above are also applicable for the receiver node.

According to an eighth aspect, network node modules for detecting security attacks in IoS applications is provided. The network node modules are configured to perform the method of the first aspect. The corresponding embodiments for the method disclosed above are also applicable for the network node modules.

According to a ninth aspect, sender node modules for detecting security attacks in IoS applications is provided. The sender node modules are configured to perform the method of the second aspect. The corresponding embodiments for the method disclosed above are also applicable for the sender node modules.

According to a tenth aspect, receiver node modules for detecting security attacks in IoS applications is provided. The receiver node modules are configured to perform the method of the third aspect. The corresponding embodiments for the method disclosed above are also applicable for the receiver node modules.

According to an eleventh aspect, a system for detecting security attacks in IoS applications is provided. The system comprises any combination of at least one network node according to the fifth aspect, at least one sender node according to the sixth aspect, and at least one receiver node according to the seventh aspect.

Advantageously these methods, the network node, the sender node, the receiver node, these computer program products, and the system provide a reliable and effective detection of security/malicious security attacks in the IoS applications, facilitating the use of senses, before being executed at the receiver.

### BRIEF DESCRIPTION OF THE DRAWINGS

For a better understanding of the inventive concept, and to show how it may be put into effect, reference will now be made, by way of exemplary embodiments, to the accompanying drawings, wherein:

FIG. 1 shows a schematic illustration of an exemplary composition of a system of a network node, a sender node and a receiver node, according to some example implementations of the present disclosure;

FIG. 2 shows another schematic illustration of an exemplary scenario where the invention is realized as an Anti-Bullying Service (ABS);

FIG. 3 shows a flow diagram of the method steps performed by the network node, according to the first aspect;

FIG. 4 shows a schematic illustration of a general composition of the system where different data inputs, including the sensory data as tactile signals converted from ElectroEncephaloGram (EEG) signals and different analyses are used;

FIG. 5 shows a signalling diagram of an exemplary scenario where the method steps are performed by the network node, according to the first aspect;

FIG. 6 shows a signalling diagram of an exemplary scenario where the method steps are performed by the sender node;

FIG. 7 shows another signalling diagram of an exemplary scenario where the method steps are performed by the receiver node;

FIG. 8 shows a flow diagram of the method steps by the sender node, according to the second aspect;

FIG. 9 shows a flow diagram of the method steps by the receiver node, according to the third aspect;

FIG. 10 shows a schematic illustration of the components (functional units) of a node, according to some example implementations of the present disclosure;

FIG. 11 shows a schematic illustration of a computer program product, according to some example implementations of the present disclosure;

FIG. 12 shows a schematic illustration of the components (functional modules) of the network node, according to some example implementations of the present disclosure;

FIG. 13 shows a schematic illustration of the components (functional modules) of the sender node, according to some example implementations of the present disclosure;

FIG. 14 shows a schematic illustration of the components (functional modules) of the receiver node, according to some example implementations of the present disclosure.

### DETAILED DESCRIPTION

The inventive concept will be described more fully hereinafter with reference to the accompanying drawings, in which certain embodiments are shown. These embodiments are provided by way of example. Like numbers refer to like elements throughout the description. Any step or feature illustrated by dashed lines should be regarded as optional.

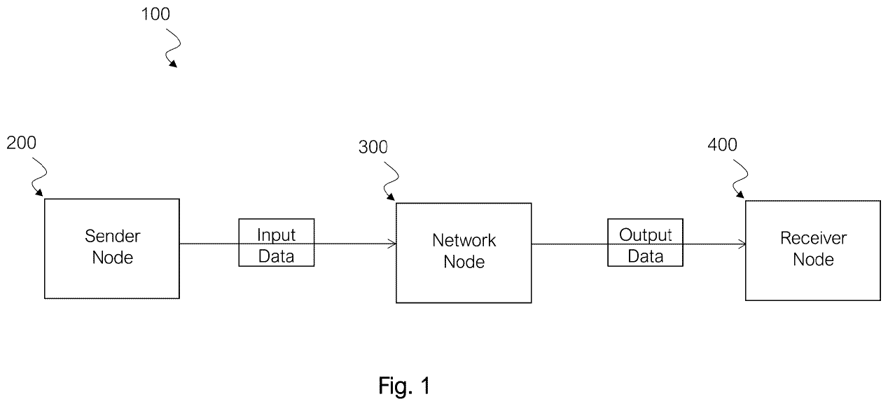

FIG. 1 shows a schematic diagram illustrating an example of a system 100 where embodiments presented herein can be applied.

The system 100 herein comprises a sender node 200, a network node 300 and a receiver node 400. It will be appreciated that the members 200, 300, 400 of the system 100 are not limited to any particular number of nodes, devices or entities.

According to the present invention, a cyber-physical system can be modeled for an IoS application by taking into account the following three main steps:
obtaining/collecting input (e.g., sensory/context/network/additional) data from the sender node 200;
processing the input data at the network node 300 and determining output (e.g., determination of anomaly) data;
transmitting the output data to the receiver node 400.

Anomaly is an abnormal behavior or a suspicious activity in the communication network that might end up compromising network operations through hidden infections, data theft, or other malicious activities.

The network node 300 is configured for detecting security attacks in IoS applications where senses are included in digital communication using devices.

The network node 300 can be realized as a respective standalone device or as a part of a device or a hardware (e.g., a radio device, a base station) or a software. Alternatively, functionality of the network node 300 may be distributed over different physical or virtual entities which may either be part of the same network part or may be spread between at least two such network parts. Thus, a part of the method steps performed by the network node 300 may be executed in a physical/virtual entity and another part of the method steps may be executed in another physical/virtual entity. The herein disclosed embodiments are not limited to any particular number of physical/virtual entities. Hence, the methods according to the herein disclosed embodiments are suitable to be performed by the network node 300 residing in a cloud computational environment.

The sender node 200 and the receiver node 400 can be realized as a user equipment (UE), a mobile or portable station and/or any radio/wireless device to communicate wirelessly with network nodes and/or other wireless devices. Communicating wirelessly may involve transmitting and/or receiving wireless signals using electromagnetic waves, radio waves, infrared waves, and/or other types of signals suitable for conveying information through air. Examples of the sender node 200 and the receiver node 400 include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device.

Embodiments relating to further details of detecting security attacks in IoS applications as performed according to the invention will now be disclosed.

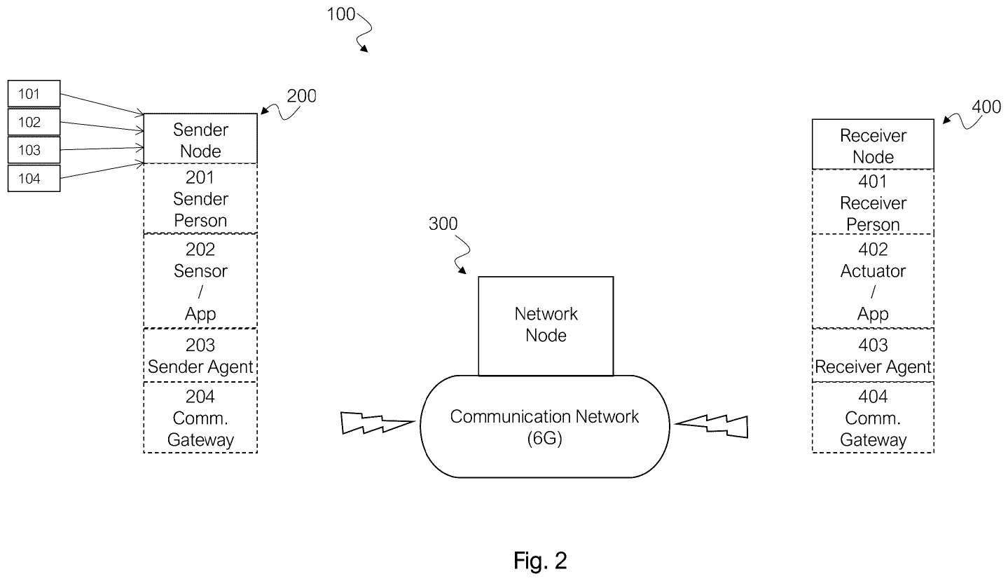

Reference is made to FIG. 2 illustrating a system 100 where the invention is realized as an Anti-Bullying Service (ABS) by the network node 300.

The network node 300 makes an evaluation of the potentially irritating/harmful feeling or perception based on a sensory data collected via a sensor 202 or an application 202 at the sender node 200 and transmits the evaluation result (e.g., determination of anomaly) to the receiver node 400 which is able to feel the related sense via an actuator 402 or an application 402. Thus, in case the sender person 201 intends to apply a bullying behavior, such as an abusive touch, on a receiver person 401 through an IoS application, the network node 300 detects it and informs the receiver person 401 accordingly. If the receiver person 401 decides on not propagating further, this bullying activity is not experienced by the receiver person 401 since it will not be sent to the actuator 402. The sender person 201 and/or the receiver person 401 can be an individual or a group of individuals.

Depending on the senses involved in the IoS application, the sensor 202 at the sender node 200 or the actuator 402 at the receiver node 400 could be in different forms, such as glove, full body dress, VR/XR glass, camera, smart watch, full body dress, ultrasonic transducer, brain computer interface. For instance, in an early IoS application, called Kissenger which sends kiss feeling between those in remote relationships, the sensor 202 measures pressure on different parts of the lip at the sender person 201. The actuator 402, which is a silicon-made lip-shaped device, projects these pressures onto the lip of the receiver person 401.

An agent is a piece of software, either a thread or code, carrying its execution state to perform the network function or an application. It can act as a middleware which performs network and other application-related functions based on underlying infrastructure. Hence, security agents may be deployed under the invention concept herein, as they are ideal for distributed networks with remote locations. Agents also provide benefits, such as performing more specialized scanning or monitoring of components or services, blocking, as a firewall, network connections based on rules/policies, defending proactively against the spread of attacks and blocking them, performing tasks independently or executing locally on data at their destination, thus reducing network traffic and latency. Therefore, this invention allows third party Internet of Senses applications, which do not have cyberbullying detection capability, to utilize the proposed method through use of agents.

A sender agent 203, which performs particular tasks including method steps of the invention disclosed below, can mediate interaction between the sensor/application (202) and a communication gateway 204. Similarly, a receiver agent 403, which performs particular tasks including method steps of the invention disclosed below, can mediate interaction between the actuator/application 402 and a communication gateway 404.

The sender agent 203 and/or the receiver agent 403 can be realized as a respective standalone device or as a part of one further device or a hardware (e.g., a radio device) or a software. Alternatively, functionality of the sender agent 203 and/or the receiver agent 403 may be distributed over different physical or virtual entities which may either be part of the same network part or may be spread between at least two such network parts. Thus, a part of the method steps performed by the sender agent 203 and/or the receiver agent 403 may be executed in a physical/virtual entity and another part of the method steps may be executed in another physical/virtual entity. The herein disclosed embodiments are not limited to any particular number of physical/virtual entities. Hence, the methods according to the herein disclosed embodiments are suitable to be performed by the sender agent 203 and/or the receiver agent 403 residing in a cloud computational environment.

The communication gateway 204 at the sender node 200 and/or the communication gateway 404 at the receiver node 400 is, for example, a mobile application gateway providing routing functionalities, service functionalities and admission control, as well as connecting nodes/devices on a cellular or carrier network with individual networks, such as enterprise networks or residential networks.

In the embodiment of FIG. 2, the network node 300 runs as a network or cloud application. In this way, determination of anomaly (and so prevention of cyberbullying) can be provided for any IoS application running on a communication network, like 6G, as a value-added service by the mobile network operator without requiring a change in the IoS application itself.

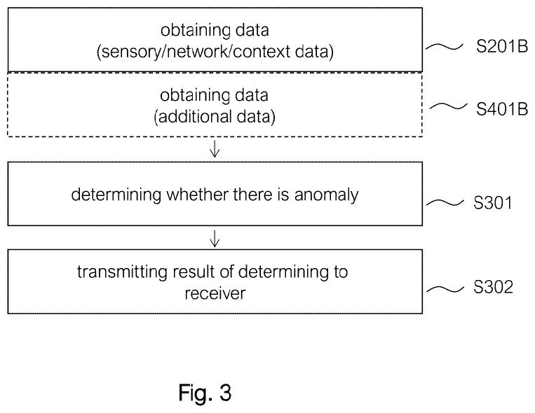

FIG. 3 illustrates the method steps performed by the network node 300 for detecting security attacks in IoS applications, according to the first aspect.

S201B: The network node 300 obtains relevant data for detecting security attacks in IoS applications. The network node 300 obtains S201B, from the sender node 200, the sensory data 101 and at least one of network data 102 or context data 103 to be used in the next step of determining S301 anomaly.

S401B: The network node 300 may also obtain S401B additional data 104 from the receiver node 400 to be used as an additional input in the determining step S301. The additional data 104 may be in the form of the sensory data 101 obtained from one or more sensors, not shown in FIG. 2, (e.g., sensors configured to obtain sensory data), the network data 102 or the context data 103.

In some embodiments, the sensory data 101 may be based on at least one of touch, smell, taste, heat or similar senses. The sensory data 101 can be obtained from one or more sensors (e.g., sensors configured to obtain sensory data), such as one or more sensors of one or more network nodes. Existing infrastructure of the sender node 200 or the receiver node 400 can be used for the acquisition of the sensory data 101.

In some embodiments, the network data 102 may comprise an internet protocol (IP) address of at least one of the sender node 200, the receiver node 400, the sensor 202, the actuator 402, or devices used by the sender person 201 or the receiver person 401. The network data 102 can be from one or more internet services and/or one or more network sensors (e.g., sensors configured to obtain network data), such as one or more sensors of one or more network nodes.

In some embodiments, the context data 103 may comprise at least one of environmental information, neighborhood information, energy consumption information or aim of communication of the sender node 200. Preferably existing infrastructure of the sender node 200 can be used for the acquisition of the context data 103.

In some embodiments, the environmental information may comprise an information indicative of at least one of temperature, humidity, time or location in the environment of at least one of the sender node 200, the receiver node 400, the sensor 202, the actuator 402, the sender person 201 or the receiver person 401. The environmental information can be from one or more environmental sensors, location sensors (e.g., GPS sensor). The location information may comprise information indicative of at least one of a geographical location, a relative location or an indoor location of the entities mentioned above.

In some embodiments, the neighborhood information may comprise information indicative of existence of other entities than the above-mentioned entities. The other entities may be sensed around the above-mentioned entities, e.g., within a predefined area around the above-mentioned entities or within a predefined distance to the above-mentioned entities. The neighborhood information can be from one or more neighborhood sensors.

In some embodiments, the energy consumption information may comprise information indicative of electrical consumption of at least one of the sender node 200, the receiver node 400, the sensor 202, the actuator 402, the sender agent 203 or the receiver agent 403. In some embodiments involving electrical consumption information, the electrical consumption information may comprise a current rate, a voltage rate, a power, a power factor, an active power measurement, a reactive power measurement, a frequency, phase information, and/or any other electrical consumption information of the above-mentioned entities. In some embodiments, the energy consumption information can be from one or more energy consumption sensors (e.g., one or more sensors configured to obtain energy consumption information).

In some embodiments, at least one of the sensory data 101, the network data 102, the context data 103 or the additional data 104 may be subject to data encryption. In such a case, a privacy enhancing transformation (PET) is applied at the sender node 200 or the receiver node 400, prior to the obtaining step S201B, S401B, to ensure the privacy preservation of the parties involved in the IoS communication. This part will be detailed later in the description where the method steps performed by the sender node 200 and the receiver node 400 are disclosed.

S301: Following the obtaining step S201B, S401B, the network node 300 determines S301 whether there is anomaly by applying some analysis, a payload-based analysis and a packet-based analysis.

The network node 300 applies the payload-based analysis to at least one of the sensory data 101 or to the context data 103. It will be understood that the two ways of the payload-based analysis, the payload-based analysis to the sensory data 101 and the payload-based analysis to the context data 103, may be employed interchangeably (additionally, alternatively) or simultaneously (concurrently).

The network node 300 applies the packet-based analysis to the network data 102.

It will be understood that, the two ways of the analysis, the payload-based analysis and the packet-based analysis, may be employed interchangeably (additionally, alternatively) or simultaneously (concurrently).

In the payload-based analysis, a payload of data packets is analyzed. In the payload-based analysis, a machine learning (ML) model or an algorithmic model, e.g. a rules-based model, is employed for determining S301 anomaly. It will be understood that, both models, the ML model and the algorithmic model, may be employed interchangeably (additionally, alternatively) or simultaneously (concurrently).

In the packet-based analysis, a pattern of network data packet traffic is analyzed. For this, a sample, w, of network traffic features, such as statistical moments (e.g. mean, kurtosis, skewness), entropy, periodic components, Hurst parameters, frequency domain features, within a pre-determined time interval, t, is selected. A feature set is extracted from the selected sample. The extracted feature set is fed into an ML model that is applicable to a new network data 103 to identify similarities in a pattern of network data packet traffic.

In the packet-based analysis, an ML model or an algorithmic model, e.g. a rules-based model, is employed for determining S301 anomaly. It will be understood that, both models, the ML model and the algorithmic model, may be employed interchangeably (additionally, alternatively) or simultaneously (concurrently).

The rules-based models produce pre-defined outcomes that are based on a set of certain rules coded manually by humans. The rules-based models are simple as they utilize deterministic approach rather than probabilistic approach. Hence, they can operate with simple basic information and data.

The ML model may be a neural network, for example, but it will be understood that other ML models may generally be employed. It will be understood that the employment of the ML model, when compared to the rules-based model, may particularly be beneficial in complex scenarios in which the definition of an excessive number of rules may be inexpedient and when it is difficult to cover all possible cases by rules, avoiding undefined input situations. The ML models may provide decisions effectively regardless of the size of input data. For example, as the amount of input data increases, the maintenance of manually-coded rules-based systems may become more complicated. While, for each new input, new rules may need to be added to the decision-making mechanism in a rule-based system, ML-based decision-making may handle such undefined situations easily. Updating a ML-based system may also be easier because the relevant “rules” may automatically be extracted from the training data by the ML model.

The training data used for the training of the ML models in the payload-based analysis may comprise historical sensory data 101 and historical context data 103. The training data used for the training of the ML model in the packet-based analysis may comprise historical feature set. The training data should be labeled as normal or abnormal in order to be used by the ML models for training. For example, a normal data packet traffic sample (a normal network data) can be obtained from the network during the normal condition of the network, when there is no anomaly determined S301 in the system 100.

S302: Following the determining step S301, the network node 300 transmits S302, to the receiver node 400, a result of the determining S301.

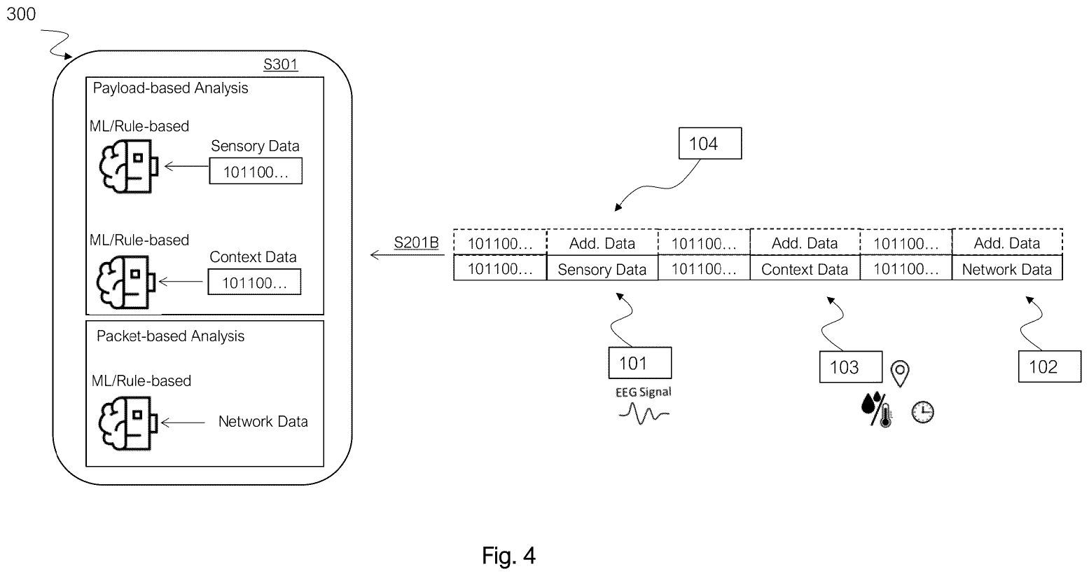

FIG. 4 illustrates an exemplary scenario where tactile signals converted from EEG signals are obtained S201B as the sensory data 101. Optionally after being encrypted, all the input data 101, 102, 103, 104 are analyzed S301 according to the payload-based analysis or the packet-based analysis depending on their labels, e.g. sensory, network or context, in the network node 300.

It will be understood that, the additional data 104 is analyzed according to the payload-based analysis, if the additional data 104 represents the sensory data 101 and/or the context data 103. The additional data 104 is analyzed according to the packet-based analysis, if the additional data 104 is labeled as the network data 102.

Embodiments relating to further details of detecting security attacks in IoS applications as performed by the network node 300 will now be disclosed.

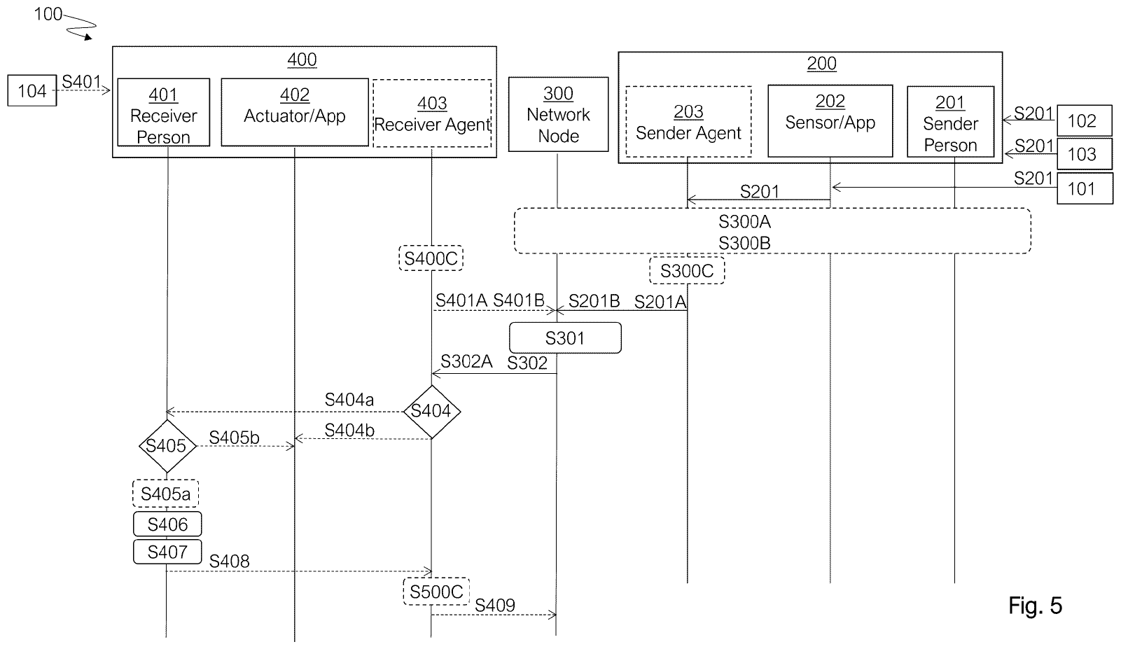

Reference is now made to FIG. 5 illustrating a signalling diagram with signals being exchanged in the system 100 comprising the sender node 200, the network node 300 and the receiver node 400 according to the first aspect.

In some embodiments, the system 100 may comprise at least one of the sender agent 203 or the receiver agent 403 located in the sender node and receiver node, respectively. The sender agent 203 interacts with the network node 300 and the sensor/app 202, while the receiver agent 403 interacts with the network node 300 and the actuator/app 402 or the receiver person 401.

S201B: When the sender node 200 comprises the sender agent 203, the network node 300 may obtain the sensory data 101 and at least one of the network data 102 or the context data 103 from the sender agent 203.

S302: When the receiver node 400 comprises the receiver agent 403, the network node 300 may transmit S302 the result of the determining S301 to the receiver agent 403.

S300A, S300B: In some embodiments, some optional method steps S300A, S300B may be performed by the network node 300 at any time, e.g., before, during or after any of the method steps of detecting security attacks in IoS applications.

Such optional steps performed by the network node 300 are first authenticating S300A and then authorizing S300B at least one of the sender node 200, the sender agent 203 or the sender person 201.

In the authenticating S300A, different mechanisms, such as multi-factor authentication, password-based authentication or biometric-based authentication, can be used in order to prevent impersonation, e.g. of the sender person 201 who impersonates someone, like parent or spouse, with intimate touch privileges.

The context data 103 and a timestamp for the context data 103 can be used to generate an authentication token. Generating dynamic credentials (in the form of the authentication token) makes the authenticating S300A dynamic (e.g. a continuous authentication at run time), as the credentials change over time depending on the context data 103 at that time. When the timestamp is used in the authenticating S300A, the topicality of the authentication token can be checked and tokens can be invalidated based on the fact, that are dated before a certain pre-determined period. This provides protection against security/malicious attacks and forces the use of topical tokens.

Similarly, the sensory data 101 can be used in authenticating S300A based on anomaly detection mechanisms. For this, user behaviours, such as voice, motion characteristics, biometric, are analyzed to mitigate impersonation attacks. When any anomaly is detected, a new authentication mechanism mentioned above is enforced for the next communication. Moreover, some other precautionary actions, such as sending a warning message to the receiver person 401, can be taken.

In the authorizing S300B, at least one of the sender node 200, the sender agent 203 or the sender person 201 authenticated S300A are authorized to perform allowed actions in allowed ways.

For this, identities of the sender person 201 and the receiver person 401 and relationship between them are considered. The relationship can be defined as allowed actions related to the identities or to the roles of the identities, such as parent-child relationship. The authorization can be built based on roles (e.g., as family, friend, relationship, teacher-student), attributes (e.g., age, gender, race, education level), or identities of users. This authorization can be used by applying a rules-based model or an ML-based model. This authorization grants or revokes permissions to perform actions for a corresponding sensory interaction, accordingly. A context-aware and granular authorization can also be used based on attributes, such as user identity, location, device security status, and IP address. In the steps of the authenticating S300A and the authorizing S300B, the sender agent 203 may also be used.

Embodiments relating to further details of detecting security attacks in IoS applications as performed by the sender node 200 will now be disclosed.

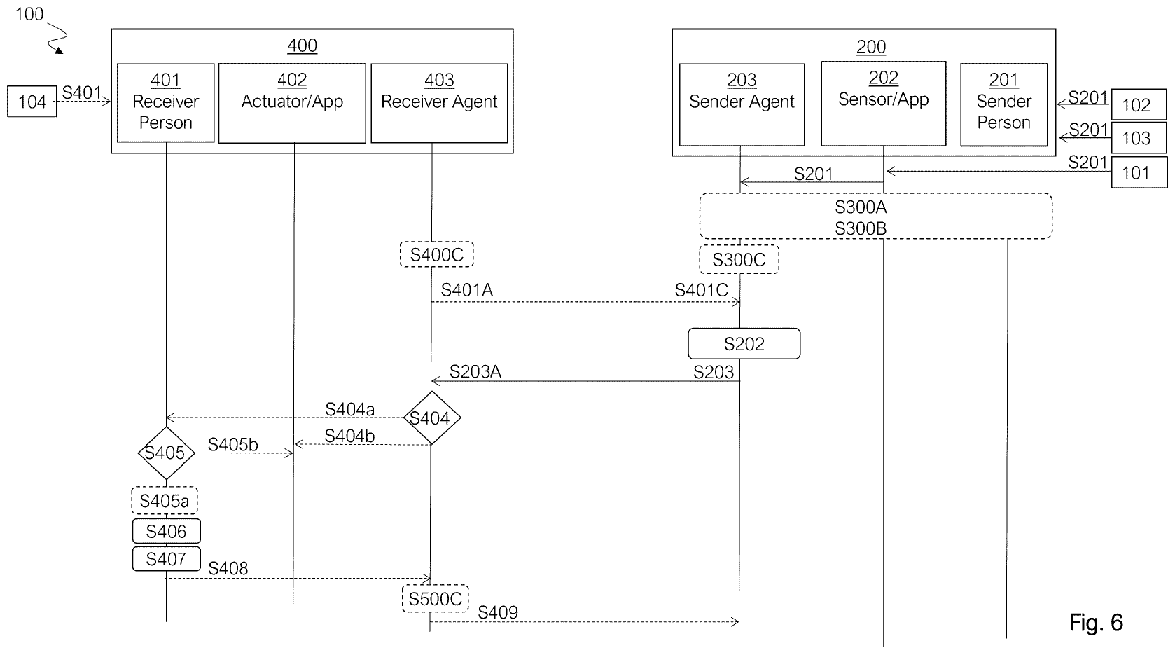

Reference is now made to FIG. 6 illustrating a scenario where the method steps are performed by the sender node 200, specifically by the sender agent 203.

S201: According to the embodiment in FIG. 6, the sender agent 203 obtains S201 all relevant data for detecting security attacks in IoS applications. The sender agent 203 obtains S201 the sensory data 101 and at least one of the network data 102 or the context data 103 to be used in the next step of determining S202 anomaly.

S401C: The sender agent 203 may also obtain S401C additional data 104 from the receiver node 400 to be used as an additional input in the determining step S202.

S202: Following the obtaining steps S201, S401C, the sender agent 203 determines S202 whether there is anomaly by applying some analysis, a payload-based analysis and a packet-based analysis.

S202: The details of the determining S202 are the analogous with the determining S301 disclosed above.

S203: Following the determining step S202, the sender agent 203 transmits S203 a result of the determining S202 to the receiver node 400 or to the receiver agent 403.

Embodiments relating to further details of detecting security attacks in IoS applications as performed by the receiver node 400 will now be disclosed.

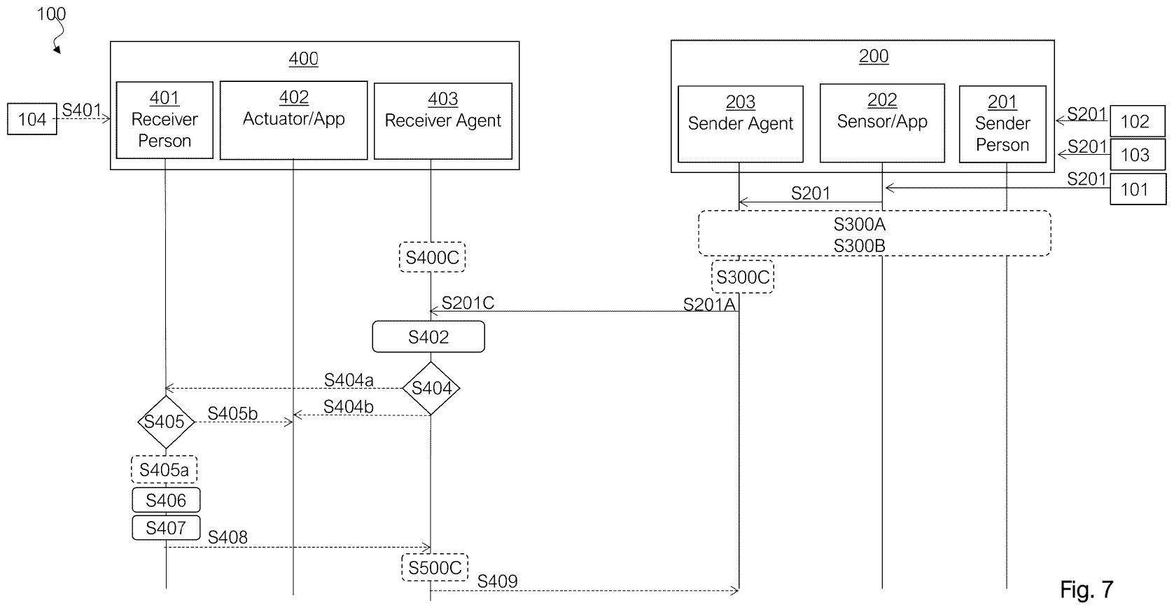

Reference is now made to FIG. 7 illustrating a scenario where the method steps are performed by the receiver node 400, specifically by the receiver agent 403.

S201C: According to the embodiment in FIG. 7, the receiver agent 403 obtains S201C all relevant data for detecting security attacks in IoS applications. The receiver agent 403 obtains S201C the sensory data 101 and at least one of the network data 102 or the context data 103 to be used in the next step of determining S402 anomaly.

S401: The receiver agent 403 may also obtain S401 additional data 104 to be used in the determining step S402. Following the obtaining step S201C, the receiver agent 403 determines S402 whether there is anomaly by applying some analysis, a payload-based analysis and a packet-based analysis.

S402: The details of the determining S402 are the analogous with the determining S301 disclosed above.

S404: Following the determining step S402, the receiver agent 403 performs (S404) one of at least two different actions depending on a result of the determining (S402) anomaly. The details with regard to the actions will be disclosed later in the description.

The sender agent 203, the receiver agent 403 and the network node 300 itself can all be considered as network/cloud services in an embodiment where the IoS applications run on cloud or edge.

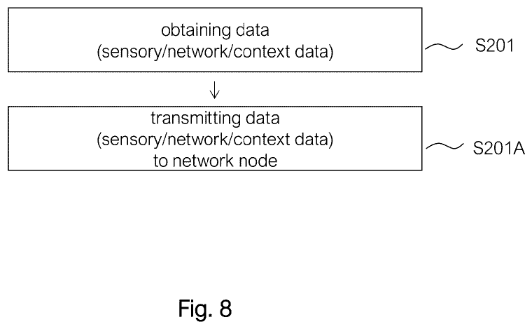

FIG. 8 illustrates the method steps performed by the sender node 200 for detecting security attacks in IoS applications, according to the second aspect.

S201: The sender node 200 obtains S201 the sensory data 101 and at least one of the network data 102 or the context data 103.

S201A: The sender node 200 then transmits S201A the sensory data 101 and at least one of the network data 102 and the context data 103 to the network node 300 which determines S301 anomaly by applying at least one of a payload-based analysis to at least one of the sensory data 101 or to the context data 103; or a packet-based analysis to the network data 102.

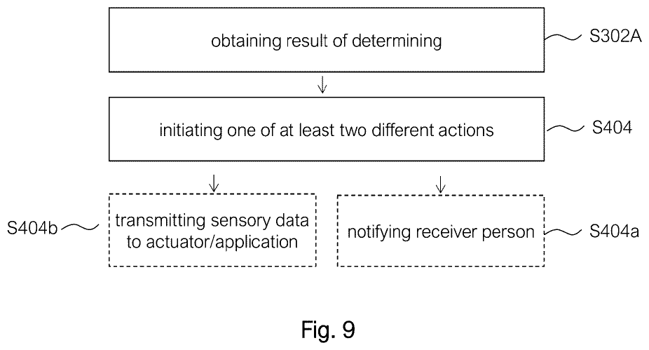

FIG. 9 illustrates the method steps performed by the receiver node 400 for detecting security attacks in IoS applications, according to the third aspect.

S302A: The receiver node 400 obtains S302A, from the network node 300, the result of the determining step S301 where anomaly has been determined by applying at least one of a payload-based analysis to at least one of a sensory data 101 or to a context data 103 obtained by the sender node 200; or a packet-based analysis to the network data 102 obtained by the sender node 200.

S404: The receiver node 400 initiates (S404) one of at least two different actions depending on the result of the determining (S301) anomaly.

S404a: The receiver node 400 notifies S404a the receiver person 401, if the result of the determining S301 is anomaly.

S404b: The receiver node 400 transmits S404b the sensory data 101 to the actuator 402 or to the application 402, if the result of the determining S301 is not anomaly.

S405: When notified S404a, the receiver person 401 performs (S405) one of at least another two different actions depending on the desired level of engagement of the receiver person 401 with the sensory data 101 or on his/her sensitiveness to potential bullying.

S405a and S405b: The receiver person 401 either blocks S405a the sensory data 101 from the actuator 402 or to the application 402; or initiates S405b a transmission of the sensory data 101 to the actuator 402 or to the application 402 for a certain period of time until being sure about the bullying.

S406 and S407: As shown in FIGS. 5 to 7, depending on the experience with the sensory data 101 encountered during a session of the IoS application, the receiver person 401 can perform at least one of logging S406 the sensory data 101 or updating S407 a policy configuration which is preferably pre-determined or set as default.

The policy configuration defines measures to be taken in response to the result of the determining S301, such as logging. The policy configuration also defines parameters to be used in the determining S301 by the network node 300, such as threshold values used in the analysis, the payload-based analysis or the packet-based analysis.

S408 and S409: The receiver person 401 can transmit S408 at least one of a result of the logging S406 or the updated S407 policy configuration the network node 300 in cleartext. The result of the logging S406 and/or the updated S407 policy configuration may also be transmitted S409 to the network node 300 in a privacy preserved form. In order to keep the result of the logging S406 and/or the updated S407 policy configuration private from the network node 300, the result of the logging S406 and/or the updated S407 policy configuration may be encrypted S500C by the receiver node 400 or the receiver agent 403 before being transmitted S409 to the network node 300.

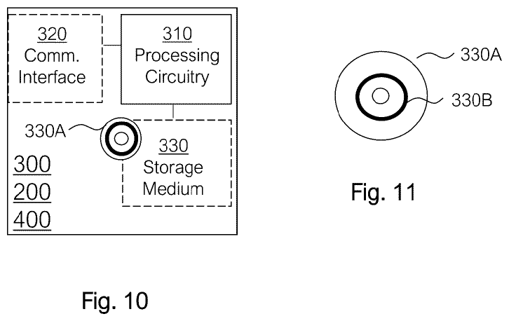

FIG. 10 schematically illustrates, in terms of a number of functional units, the components of the network node 300, the sender node 200 and the receiver node 400, according to some example implementations of the present disclosure.

A processing circuitry 310 is provided using any combination of one or more of a suitable central processing unit (CPU), multiprocessor, microcontroller, digital signal processor (DSP), etc., capable of executing software instructions stored in a computer program product 330A (as in FIG. 11), e.g. in the form of a storage medium 330. The network node 300, the sender node 200 and the receiver node 400 may further comprise a communications interface 320 for communications with each other. As such the communications interface 320 may comprise one or more transmitters and receivers, comprising analogue and digital components.

As depicted in FIG. 11, the computer program product 330A comprises computer program 330B code portions that, when executed a processing circuitry 310, configure the processing circuitry 310 to perform the method of any one of the example implementations in accordance with the first, the second or the third aspect. The computer program product may hereby, in some examples, be stored on a computer-readable storage medium or encoded in a data signal.

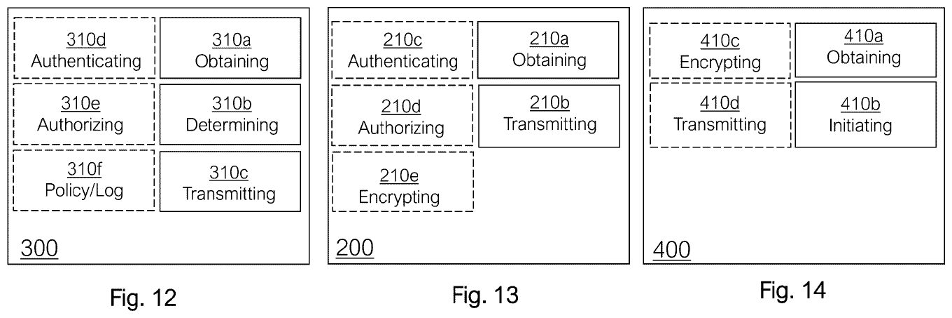

FIG. 12 schematically illustrates, in terms of a number of functional modules, the components of the network node 300 according to the fifth aspect. The network node 300 comprises the modules configured to perform the method of the first aspect.

The network node 300 of FIG. 12 comprises the functional modules of an obtaining module 310a configured to perform the obtaining S201B, S401B, a determining module 310b configured to perform the determining S301 and a transmitting module 310c configured to perform the transmitting S302. The network node 300 of FIG. 12 may further comprise a number of optional functional modules, such as at least one of an authenticating module 310d configured to perform the authenticating S300A, an authorizing module 310e configured to perform the authorizing S300B or a policy/log module 310f configured to perform a step in response to the transmitting S409 the at least one of the result of the logging S406 or the updated S407 policy configuration. In general terms, each functional module 310a-310f may be implemented in hardware or in software. At least one of the functional modules of the network node 300 may be embedded in a single device or installed separately. Preferably, one or more or all functional modules 310a-310f may be implemented by the processing circuitry 310, possibly in cooperation with the communications interface 320 and/or the storage medium 330. The processing circuitry 310 may thus be arranged to fetch, from the storage medium 330, instructions as provided by one or more or all functional modules 310a-310f and to execute these instructions, thereby performing any steps of the network node 300 as disclosed herein.

FIG. 13 schematically illustrates, in terms of a number of functional modules, the components of the sender node 200 according to an embodiment. The sender node 200 comprises the modules configured to perform the method of the second aspect.

The sender node 200 of FIG. 13 comprises the functional modules of; an obtaining module 210a configured to perform the obtaining S201, and a transmitting module 210b configured to perform the transmitting S201A. The sender node 200 of FIG. 13 may further comprise a number of optional functional modules, such as at least one of an authenticating module 210c configured to perform the authenticating S300A, an authorizing module 210d configured to perform the authorizing S300B, and an encrypting module 210e configured to perform the encrypting S300C. In general terms, each functional module 210a-210e may be implemented in hardware or in software. At least one of the functional modules may be embedded on the sender node 200 or installed separately. Preferably, one or more or all functional modules 210a-210e may be implemented by the processing circuitry 310, possibly in cooperation with the communications interface 320 and/or the storage medium 330. The processing circuitry 310 may thus be arranged to fetch, from the storage medium 330, instructions as provided by one or more or all functional modules 210a-210e and to execute these instructions, thereby performing any steps of the sender node 200 as disclosed herein.

FIG. 14 schematically illustrates, in terms of a number of functional modules, the components of the receiver node 400 according to an embodiment. The receiver node 400 comprises the modules configured to perform the method of the third aspect.

The receiver node 400 of FIG. 14 comprises the functional modules of; an obtaining module 410a configured to perform the obtaining S302A, and a initiating module 410b configured to perform the initiating S404 one of at least two different actions. The receiver node 400 of FIG. 14 may further comprise a number of optional functional modules, such as at least one of an encrypting module 410c configured to perform the encrypting S500, and a transmitting module 410d configured to perform the transmitting S409. In general terms, each functional module 410a-410d may be implemented in hardware or in software. At least one of the functional modules may be embedded on the receiver node 400 or installed separately. Preferably, one or more or all functional modules 410a-410d may be implemented by the processing circuitry 310, possibly in cooperation with the communications interface 320 and/or the storage medium 330. The processing circuitry 310 may thus be arranged to fetch, from the storage medium 330, instructions as provided by one or more or all functional modules 410a-410d and to execute these instructions, thereby performing any steps of the receiver node 400 as disclosed herein.

In view of the above, in some examples, a reliable and effective system 100 for detecting a security attack (in the form of sense-related bullying activity) in the IoS applications, facilitating the use of senses, can be provided. The system 100 comprises any combination of the network node 300 according to the fifth aspect, the sender node 200 according to the sixth aspect, and the receiver node 400 according to the seventh aspect.

It will be appreciated that the examples and embodiments as explained above are merely illustrative and susceptible to various modifications. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

As such, the present invention is only limited by the claims that follow.

1. A method for detecting security attacks in Internet of Senses (IoS) applications performed by a network node, the method comprising:
obtaining, from a sender node, sensory data and at least one of network data or context data;
determining anomaly by applying at least one of:
a payload-based analysis to at least one of the sensory data or the context data; or
a packet-based analysis to the network data,
wherein the payload-based analysis analyzes a payload of data packets, and
wherein the packet-based analysis analyzes a pattern of data packet traffic; and
transmitting, to a receiver node, a result of the determining.

2. The method of claim 1, further comprising:
obtaining additional data from the receiver node to be used in the determining.

3. The method as claimed in claim 1, wherein the sensory data is based on at least one of touch, smell, taste or temperature.

4. The method as claimed in claim 1,
wherein the context data is based on at least one of environment, temperature, time, location, energy consumption or aim of communication.

5. The method as claimed in claim 1, wherein the payload-based analysis uses a machine learning, ML, model trained with sensory data or context data or both.

6. The method as claimed in claim 1, wherein the packet-based analysis uses a machine learning, ML, model trained with network data.

7. The method of claim 6, wherein a feature set extracted from a selected sample, w, of network traffic features within a pre-determined time interval, t, is fed into the ML model.

8. A method for detecting security attacks in Internet of Senses (IoS) applications performed by a sender node, the method comprising:
obtaining sensory data and at least one of network data or context data; and
transmitting the sensory data and at least one of the network data or the context data to a network node which determines an anomaly by applying at least one of:
a payload-based analysis to at least one of the sensory data or the context data; or
a packet-based analysis to the network data.

9. A method for detecting security attacks in Internet of Senses (IoS) applications performed by a receiver node, the method comprising:
obtaining, from a network node, a result of determining anomaly determined by applying at least one of:
a payload-based analysis to at least one of a sensory data or a context data obtained by a sender node; or
a packet-based analysis to a network data obtained by the sender node; and
initiating one of at least two different actions depending on the result of the determining anomaly.

10. The method of claim 9, wherein the action is notifying, if the result of the determining is anomaly, a receiver person.

11. The method of claim 9, wherein the action is transmitting, if the result of the determining is not anomaly, the sensory data to an actuator or to an application.

12. The method of claim 10, wherein the receiver person performs either:
blocking the sensory data; or
initiating a transmission of the sensory data to the actuator or to the application.

13. The method as claimed in claim 9, wherein the receiver person performs at least one of:
logging the sensory data; or
updating a pre-determined policy configuration which defines measures to be taken in response to the result of the determining and parameters to be used in the determining by the network node.

14. The method as claimed in claim 12, further comprising transmitting at least one of:
a result of the logging; or
the updated policy configuration to the network node.

15. A non-transitory computer-readable medium storing thereon a computer program comprising code portions that, when executed on at least one processing circuitry, configure the processing circuitry to perform the method of claim 1.

16-31. (canceled)

32. A non-transitory computer-readable medium storing thereon a computer program comprising code portions that, when executed on at least one processing circuitry, configure the processing circuitry to perform the method of claim 8.

33. A non-transitory computer-readable medium storing thereon a computer program comprising code portions that, when executed on at least one processing circuitry, configure the processing circuitry to perform the method of claim 9.
